(19) United States
(12) Patent Application Publication
(10) Pub. No.: US 2025/0244822 A1
(43) Pub. Date: Jul. 31, 2025

(54) BIFACIAL DISPLAY DEVICE

(71) Applicant: TEXAS INSTRUMENTS INCORPORATED, Dallas, TX (US)

(72) Inventor: Robert Allan NEIDORFF, Bedford, NH (US)

(21) Appl. No.: 18/428,555

(22) Filed: Jan. 31, 2024

(51) Int. Cl. G06F 3/01; G02F 1/13357; G06F 3/0481; H04N 23/57

(52) U.S. Cl. CPC G06F 3/011; G02F 1/133603; G06F 3/0481; H04N 23/57

(57) ABSTRACT

In an example, a display device includes a housing, a first display panel retained by the housing, a second display panel retained by the housing, and a light source retained by the housing, the light source configured to emit light to illuminate the first display panel and the second display panel.

### BACKGROUND

A display device includes a display panel by which information may be presented to a viewer. The display panel is illuminated by a light source to cause an image to be displayed on the display panel.

### SUMMARY

In an example, a display device includes a housing, a first display panel retained by the housing, a second display panel retained by the housing, and a light source retained by the housing, the light source configured to emit light to illuminate the first display panel and the second display panel.

In another example, a display device includes a housing, a first display panel retained by the housing, a first camera retained by the housing and having a first field of view overlapping with a first viewing angle of the first display panel, a second display panel retained by the housing, a second camera retained by the housing and having a second field of view overlapping with a second viewing angle of the second display panel, a light source retained by the housing, the light source configured to emit light to illuminate the first display panel and the second display panel, and a processor coupled to the first display panel, the second display panel, and the first camera. The processor is configured to control the first display panel to display a first image, and control the second display panel to display a second image.

In some examples, a method includes controlling a light source retained in a housing of a display device to provide light. The method also includes controlling a first display panel retained in the housing to display a first image responsive to illumination of the first display panel by the light. The method also includes controlling a second display panel retained in the housing to display a second image responsive to illumination of the second display panel by the light or by a second light retained in the housing of the display device. The first display panel and the second display panel are oriented in the housing having different viewing angles.

### BRIEF DESCRIPTION OF THE DRAWINGS

FIG. 1 is a diagram of an environment, in accordance with various examples.

FIG. 2A is a view of the environment from a perspective of a first user, in accordance with various examples.

FIG. 2B is a view of the environment from a perspective of a second user, in accordance with various examples.

FIG. 3 is a block diagram of a display device, in accordance with various examples.

FIG. 4 is a timing diagram of a modulation scheme, in accordance with various examples.

FIG. 5 is a block diagram of a display device including light guides, in accordance with various examples.

FIG. 6 is a block diagram of a display device include including a passive reflective light source, in accordance with various examples.

FIG. 7 is a block diagram of a display device including a projection light source and mirrors, in accordance with various examples.

FIG. 8 is a block diagram of a computing device, in accordance with various examples.

FIG. 9 is a flow chart of a method, in accordance with various examples.

### DETAILED DESCRIPTION

As described above, a display panel of a display device is illuminated by a light source to cause an image to be displayed on the display panel. In many applications, the display is one-sided. For example, the display device may be a computer monitor in which a back cover or housing of the display device is opaque, various components, including a light source are disposed within the housing, and a display panel serves as a front cover of the display device. The light source emits light which, alone or in combination with one or more of the various components, illuminates the display panel and causes the display panel to display an image. However, such one-sided display devices may have various challenges. In the implementation of a computer monitor, the display device may be placed in a manner that obstructs a view of one or more persons. For example, the display device may be placed on a desk in a manner such that the display monitor obstructs a first person sitting on one side of the desk from viewing a second person seated on an opposite side of the desk. Similarly, the second person may be unable to view the image displayed by the display device while the first person views the image. This may lead to challenges in sharing or discussing the image between the first and second persons.

One approach to partially address this challenge is to include a second display device having a display panel facing the second person, enabling the same, or other, images to be shown to the second person. This approach includes its own challenges, however. For example, placing two display devices back to back may have too large of a physical footprint for many application environments, may consume too much power, may be incompatible with a computing device that drives or provides images to the display device(s), or the like.

Examples of this description provide for a bifacial display device. The bifacial display device includes first and second display panels, retained by a same housing, and sharing a same light source. The first and second display panels may be oriented in opposite directions such that, for example, a viewing angle of the first display panel and a viewing angle of the second display panel are offset by 180 degrees. The bifacial display device may have a smaller physical footprint than two one-sided display devices placed back to back. In an example, the light source may emit light that illuminates both the first and second display panels. Illuminating the first and second display panels via the same light source, as opposed to separate light sources specific to each display panel, may decrease power consumption of the bifacial display device compared to two one-sided display devices placed back to back. In some examples, the light source does not simultaneously illuminate the first and second display panels. Instead, the light source may be modulated, such that the light source illuminates the first display panel at a first timing and the second display panel at a second timing, where the first timing and the second timing are each at a frequency greater than a flicker fusion frequency (e.g., a flicker rate of the first display panel and the second display panel is faster than the human eye can perceive, and therefore a human viewer does not observe a flicker resulting from the modulation of the light source).

In some examples, the bifacial display device includes one or more image capture devices, such as cameras or other sensors, on one or both sides of the bifacial display device. For example, a first camera or cameras facing a first direction may capture images for display on a display panel facing a second direction, and a second camera or cameras facing a second direction may capture images for display on a display panel facing the first direction. For example, the first camera may have a field of view overlapping with a viewing angle of the first display panel. A second camera may have a field of view overlapping with a viewing angle of the second display panel.

Based on the captured images, a processor or other controller may control the first display panel and/or the second display panel. For example, the processor may control the first display panel to display a first image and control the second display panel to display a second image (in some examples, the first image is a replica, or copy, of the second image). In an example, based on the first camera capturing an image in which a gaze of a second user (e.g., a user gaze) viewing the first display panel changes, the first image may be modified. In another example, based on a change in an image captured by the first camera, the second image may be modified. The first image may be based on, or include at least a portion of, an image captured by the second camera. Similarly, the second image may be based on, or include at least a portion of, an image captured by the first camera.

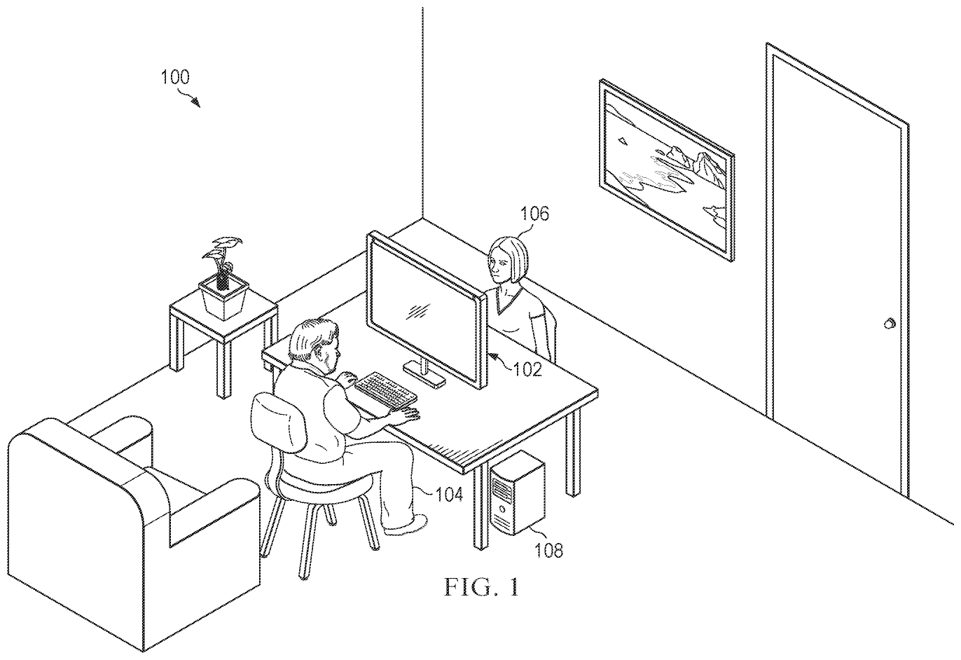

FIG. 1 is a diagram of an environment 100, in accordance with various examples. As shown in FIG. 1, the environment 100 may be representative of an office environment and includes a bifacial display device 102 having first and second display panels (not shown). However, the environment 100 may also be generally representative of any environment in which a display device 102 is provided. For example, the environment 100 may be representative of an office environment in which it may be useful to display the same, or different content, on each side of the bifacial display device 102. In another example, the environment 100 may be representative of a medical environment in which it may be useful to provide information to a patient on a first side of the bifacial display device 102 and for a medical provider (e.g., doctor, therapist, etc.) to view the same or other information on a second side of the bifacial display device 102. In yet other examples, the environment 100 may be representative of a retail environment in which a seller and a buyer view different sides of the bifacial display device 102, an advertisement environment in which different advertisements are presented on different sides of the bifacial display device 102, an entertainment environment in which different, or the same, entertainment content is presented on different sides of the bifacial display device 102, a gaming environment in which different, or the same gamin content is presented on different sides of the bifacial display device 102, or the like. In an example, the first and second display panels are viewable simultaneously from respective first and second sides of the display device 102, where the first and second sides are opposite one another.

As shown in FIG. 1, the display device 102 may at least partially obstruct a view of a first user 104 in a first direction, and of a second user 106 in a second direction opposite to the first direction. In an example, the first user 104 may view a first side of the display device 102 in which a first display panel is retained, thereby viewing the first display panel. Similarly, the second user 106 may view a second side of the display device 102 in which a second display panel is retained, thereby viewing the second display panel. In some examples, a computing device 108 is coupled to the display device 102 and configured to drive or control the display device 102 to present images on the first and/or second display panels. While shown in FIG. 1 as separate, standalone devices, in some examples the display device 102 and the computing device 108 are incorporated or integrated together in a single device, such as an all-in-one computer, a laptop computer, or the like.

In some examples, the computing device 108 controls the display device 102 to present images simultaneously to both the first user 104 and the second user 106 (e.g., first and second images, respectively). For example, the computing device 108 may control the display device 102 to provide an application window of a graphical user interface on the display device 102 for view by the first user 104 and the second user 106. In another example, the computing device 108 may control the display device 102 to provide a first application window of a graphical user interface on the display device 102 for view by the first user 104 and provide a second application window of a graphical user interface on the display device 102 for view by the second user 106. In some examples, the computing device 108 may control the display device 102 to display an image of the first user 104 alone, or in combination with other elements (such as in a picture-in-picture representation) to the second user 106, and/or vice versa. In some examples, the computing device 108 may control the display device 102 to display a background visible behind the first user 104, as if the first user 104 were absent, to the second user 106, and/or vice versa. In some examples, the computing device 108 may control the display device 102 to modify a displayed image based on detected characteristics of the first user 104 and/or the second user 106. For example, responsive to a detected change in user gaze, viewing angle (which may also be referred to as a user view angle), or position of the first user 104, the computing device 108 may control the display device 102 to modify a first displayed image provided to the first user 104 and/or a second displayed image provided to the second user 106. Similarly, responsive to a detected change in user gaze, viewing angle (which may also be referred to as a user view angle), or position of the second user 106, the computing device 108 may control the display device 102 to modify the first displayed image provided to the first user 104 and/or the second displayed image provided to the second user 106.

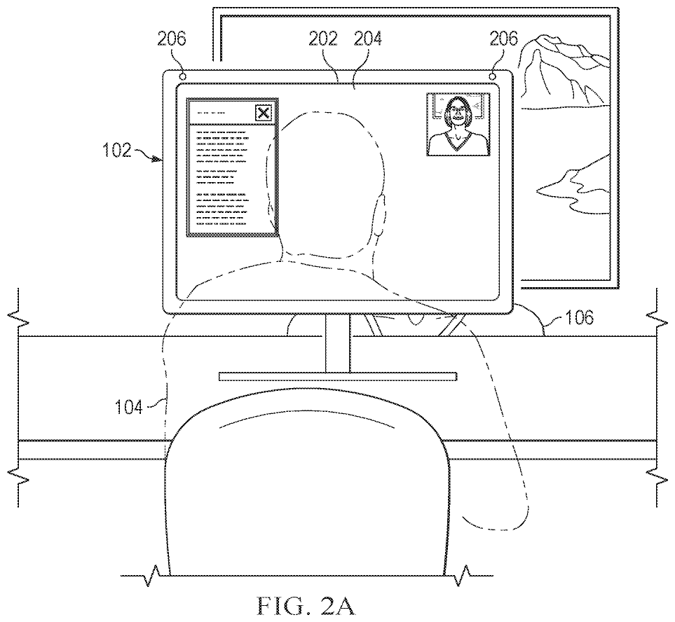

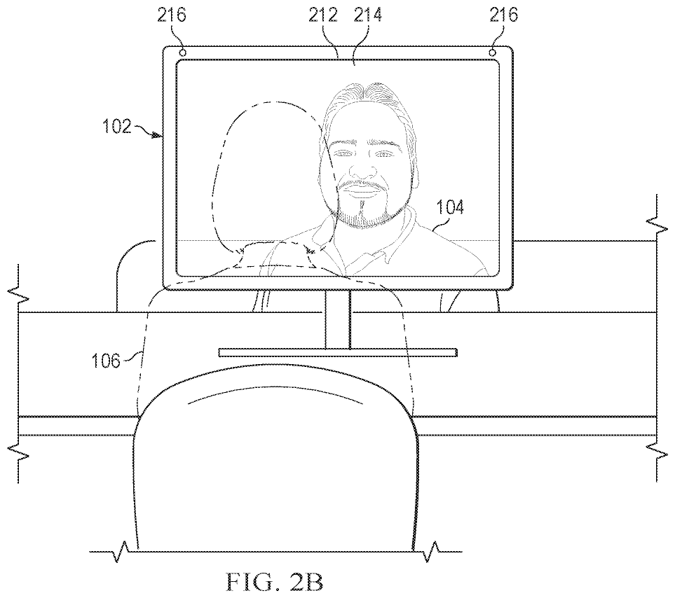

FIG. 2A is a view of the environment 100 from a perspective of the first user 104, in accordance with various examples. As shown in FIG. 2A, the display device 102 includes a first aperture 202 through which a display panel 204 is viewable by the first user 104. For example, the display panel 204 may be controllable to display a first image viewable at a first viewing angle through the first aperture 202. In an example, the display panel 204 may include one or more layers and may be implemented according to liquid crystal display (LCD) technology, light emitting diode (LED) technology, as a medium on which to project an image, or according to any other suitable display technology that relies on or utilizes a back light or light source.

FIG. 2B is a view of the environment 100 from a perspective of the second user 106, in accordance with various examples. As shown in FIG. 2B, the display device 102 includes a second aperture 212 through which a display panel 214 is viewable by the second user 106. For example, the display panel 214 may be controllable to display a second image viewable at a second viewing angle through the second aperture 212. In an example, the display panel 214 may include one or more layers ad may be implemented according to LCD technology, LED technology, as a medium on which to project an image, or according to any other suitable display technology that relies on or utilizes a back light or light source.

In an example, the display panel 204 and the display panel 214 are parallel to one another and may be oriented in opposite directions such that, for example, a viewing angle of the display panel 204 and a viewing angle of the display panel 214 are offset by 180 degrees. In this way, the second user 106 is presented with a more useful and aesthetically pleasing user experience when seated opposite the display device 102 from the user 104, in comparison to examples of the display device 102 that lack the display panel 214.

In some examples, the display device 102 includes cameras 206 disposed proximate to the display panel 204 in a surrounding housing of display device 102, surrounding the first aperture 202. While two cameras 206 are shown in FIG. 2A, in various examples, any suitable number of cameras may be provided. Similarly, in some examples, the display device 102 includes cameras 216 disposed proximate to the display panel 214 in a surrounding housing of display device 102, surrounding the aperture 212. While two cameras 216 are shown in FIG. 2B, in various examples, any suitable number of cameras may be provided. In an example, the cameras 206 have a field of view overlapping the viewing angle of the display panel 204 and the cameras 216 have a field of view overlapping the viewing angle of the display panel 214. In this way, the first user 104 may be viewable by the cameras 206 and the second user 106 may be viewable by the cameras 216.

In some examples, the computing device 108, or another processor, controller, or other computational component within the display device 102 may process images captured by the cameras 206 and/or the cameras 216. In some examples, images displayed on the display panel 204 and/or the display panel 214 may be modified based on the processing. For example, responsive to processing images captured by the cameras 216 and determining a change in user gaze of the second user 106, an image displayed on the display panel 214 may be altered. For example, a perspective of the image may be changed to correspond, complement, or otherwise adjust for the change in user gaze of the second user 106. Similarly, responsive to processing images captured by the cameras 206 and determining a change in user gaze of the first user 104, an image displayed on the display panel 204 may be altered. For example, a perspective of the image may be changed to correspond, complement, or otherwise adjust for the change in user gaze of the first user 104.

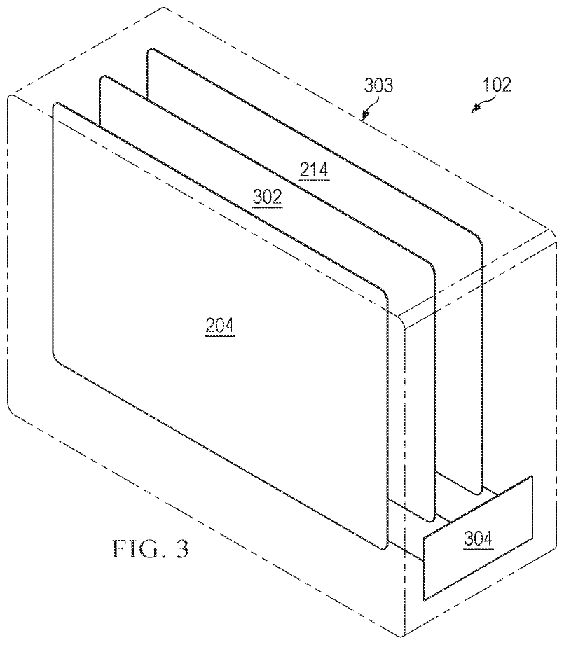

FIG. 3 is a block diagram of the display device 102, in accordance with various examples. In some examples, a light source 302 is retained by a housing 303 the display device 102. The display panel 204 and the display panel 214 may both be illuminated by the light source 302. In some examples, the light source 302 may emit light that illuminates both the display panel 204 and the display panel 214 simultaneously. Illuminating the display panel 204 and the display panel 214 simultaneously via the same light source 302, as opposed to separate light sources specific to each display panel, may decrease power consumption and physical size/area footprint of the display device 102 compared to two one-sided display devices placed back to back. In some examples, the display device 102 includes a controller 304. The controller 304 may be implemented as a microcontroller, a processor, a microprocessor, a graphics processing unit, or any other device suitable for performing processing and/or performing control functions related to the display panel 204, the display panel 214, and/or the light source 302.

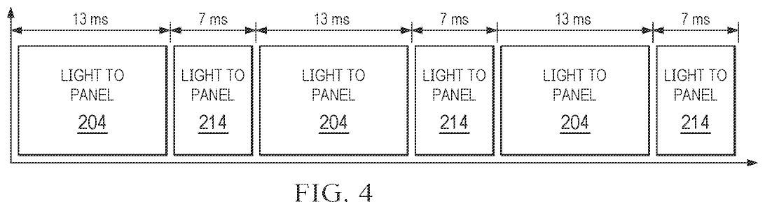

In some examples, the light source 302 does not simultaneously illuminate the display panel 204 and the display panel 214. Instead, the light source 302 may be modulated, such as by the computing device 108 or another processor, controller or other computational component within the display device 102, such that the light source 302 illuminates the display panel 204 at a first timing and the display panel 214 at a second timing (which may be the first timing plus an offset), where the first timing and the second timing are each at a frequency greater than a flicker fusion frequency (e.g., a flicker rate of the display panel 204 and the display panel 214 is faster than the human eye can perceive, and therefore a human viewer does not observe a flicker resulting from the modulation of the light source 302, or about). In example, the flicker fusion frequency is about 33 Hertz (Hz) or an image repetition rate faster than or equal to one image ever approximately 30 milliseconds (ms). An example of timing of such a modulation scheme is shown in FIG. 4. As shown in FIG. 4, the light source 302 may provide light to the display panel 204 for a first amount of time and provide light to the display panel 214 for a second amount of time. In some examples, the first amount of time is about 13 ms and the second amount of time is about 7 ms, as shown in FIG. 4. In other examples, the first amount of time is about 10 ms and the second amount of time is about 10 ms. In yet other examples, the first amount of time and the second amount of time are each any suitable value less than or equal to approximately 30 ms. In some examples, the illumination timing of the first display panel 204 versus the second display panel 214 may vary, such as to accommodate different brightness levels of the first display panel 204 or the second display panel 214, different sizes of the first display panel 204 or the second display panel 214, or the like. As further shown in FIG. 4, a period of no illumination may exist between the light source 302 illuminating, or providing light to, the first display panel 204 or the second display panel 214. This period between providing light to the first display panel 204 or the second display panel 214 may be selected based on a mechanical time consumed by the light source 302 is reconfiguring after providing light to one of the first display panel 204 or the second display panel 214 to provide light to the other of the first display panel 204 or the second display panel 214 and the illumination times for the first display panel 204 or the second display panel 214.

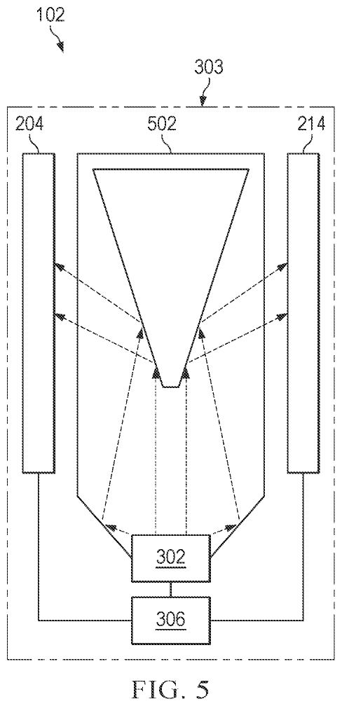

Returning to FIG. 3, in some examples, the light source is a fluorescent light source, an electroluminescent light source, or an incandescent light source. In other examples, the light source 302 is a LED light source, such as a full-array backlighting LED light source or an edge lighting LED light source. In some examples, the light source 302 is a dual-sided LED light source, such as a panel having a first set or array of LEDs on a first side of the panel (such as to illuminate the display panel 204) and a second set or array of LEDs on a second side of the panel (such as to illuminate the display panel 214). In some examples, one or more light guides (not shown) are implemented in conjunction with the light source 302 to direct or guide light. Such an example is shown in FIG. 5. As shown in FIG. 5, the light source 302 may provide illumination which is routed by a light guide 502 to the first display panel 204 and the second display panel 214. In some examples, the light guide 502 is a symmetrical edge guide, such as a right angle planal wedge guide. In other examples, the light guide 502 has any suitable structure or arrangement. In some examples, multiple light guides 502 of the same, or different, structures may be implemented in the display device 102 along with one or more light sources 302. In an example, interior surfaces of the light guide 502 may have a coating or surface treatment that facilitates the reflection of light, such as white light reflecting paint, or any other suitable coating or substance.

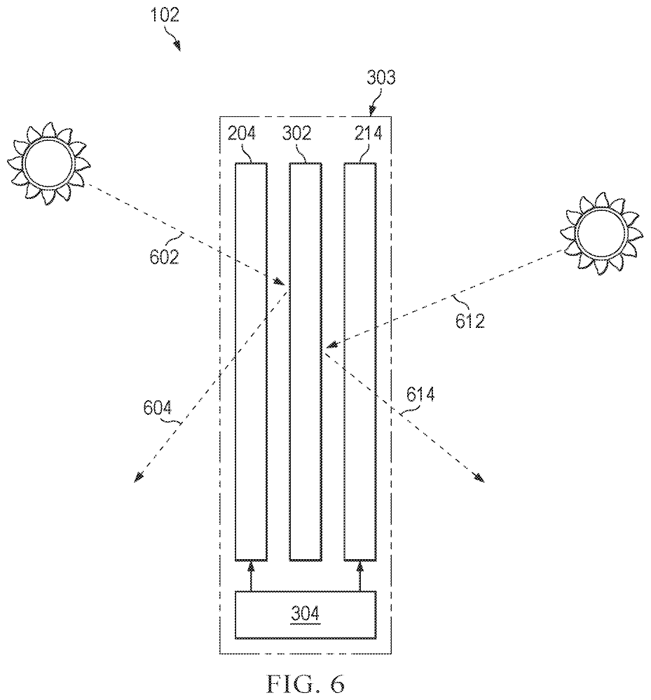

Returning to FIG. 3, in other examples, the light source 302 is a reflective surface that reflects light toward a viewer of the display panel 204 and/or the display panel 214. Such an example is shown in FIG. 6. For example, the display panel 204 and the display panel 214 may each be LCD display panels including respective front and rear polarizers. In this example, the light source 302 may be a passive component, having a reflective property on a side facing the display panel 204 such that incident light 602 passes through the display panel 204 and is reflected by the light source 302 as reflected light 604 back to the display panel 204 to illuminate the display panel 204. Similarly, the light source 302 may have a reflective property on a side facing the display panel 214 such that incident light 612 passes through the display panel 214 and is reflected by the light source 302 as reflected light 614 back to the display panel 214 to illuminate the display panel 214. In other examples, two separate surfaces having reflective properties on front surfaces may be placed back to back to form the light source 302 rather than the light source 302 including a single surface having reflective properties on both its front and back surfaces.

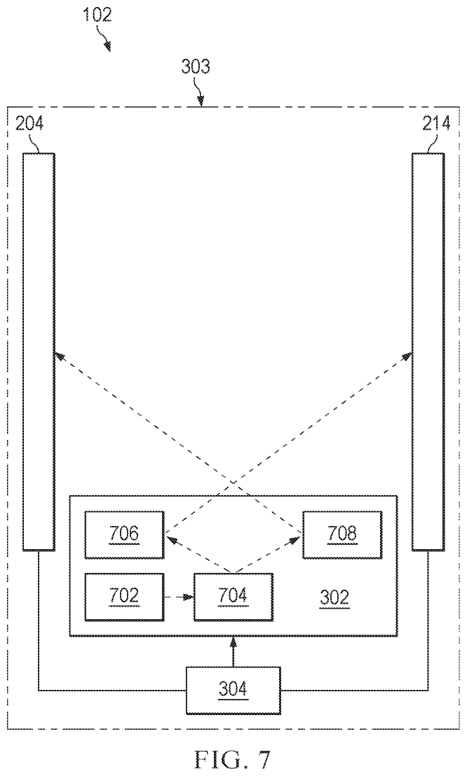

Returning to FIG. 3, in yet other examples, the light source 302 is a projection light source combined with one or more mirrors configured, arranged, oriented, or controllable to direct light toward a viewer of the display panel 204 and/or the display panel 214. Such an example is shown in FIG. 7, in which the light source 302 includes a projected light source 702, a micromirror array 704, a first mirror 706, and a second mirror 708. The projected light source 702 may be any suitable light source capable of emitting light, such as one or more LEDs, a laser, an incandescent light bulb, or the like. The micromirror array 704 may be fixed, controllable, articulable, capable of being angled, or any combination thereof. For example, the micromirror array 704 may be controlled by the computing device 108, the controller 304, or another processor, controller, or other computational component within or coupled to the display device 102 to reflect light toward or away from the first mirror and toward or away from the second mirror 708. The first mirror 706 may direct light received from the micromirror array 704 toward the display panel 204 and the second mirror 708 may direct light received from the micromirror array 704 toward the display panel 214. In some examples, the first mirror 706 and the second mirror 708 may be flat, convex, or concave, such as to expand a displayable size of an image without a corresponding increase in size of the housing 303 of the display device 102.

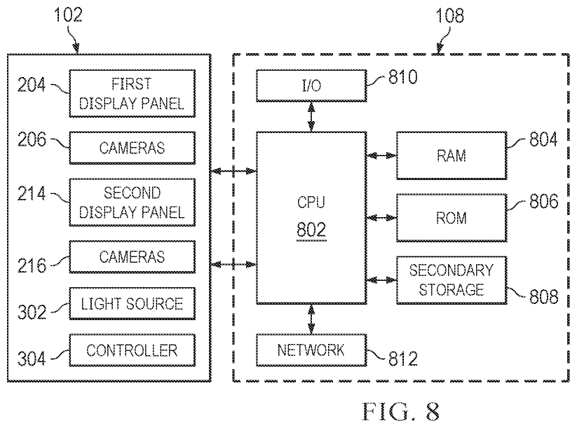

FIG. 8 is a block diagram of a computing device 108, in accordance with various examples. The computing device 108 includes a central processor unit (CPU) 802 that is in communication with memory devices including secondary storage 808, read only memory (ROM) 806, random access memory (RAM) 804, input/output (I/O) devices 810, and network connectivity devices 812. The CPU 802 may be implemented as one or more CPU chips. In some examples, the computing device 108 is implemented in an all-in-one device with the display device 102. In other examples, the computing device 108 is coupled to the display device 102. In an example, display device 102 includes the cameras 206 and/or the cameras 216, as described above, and provide captured images to the CPU 802 for processing by the CPU 802.

By programming and/or loading executable instructions onto the computing device 108, at least one of the CPU 802, the RAM 804, and the ROM 806 are changed, transforming the computing device 108 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus. In addition, a software-based implementation may enable reconfiguration in the field. For example, a skilled technician may calibrate a camera/image link based on an environment. In another example, a common user may select one of a number of pre-programmed displays. In yet a third example, a more skilled user may adjust the display configuration through a graphical user interface (GUI). The GUI, or a controller or processor that receives input via the GUI, then reprograms the display to achieve the effect desired.

Additionally, after the computing device 108 is turned on or booted, the CPU 802 may execute a computer program or application. For example, the CPU 802 may execute software or firmware stored in the ROM 806 or stored in the RAM 804. In some cases, on boot and/or when the application is initiated, the CPU 802 may copy the application or portions of the application from the secondary storage 808 to the RAM 804 or to memory space within the CPU 802 itself, and the CPU 802 may then execute instructions that the application is comprised of. In some cases, the CPU 802 may copy the application or portions of the application from memory accessed via the network connectivity devices 812 or via the I/O devices 810 to the RAM 804 or to memory space within the CPU 802, and the CPU 802 may then execute instructions that the application is comprised of. During execution, an application may load instructions into the CPU 802, for example load some of the instructions of the application into a cache of the CPU 802. In some contexts, an application that is executed may be said to configure the CPU 802 to do something, e.g., to configure the CPU 802 to perform the function or functions promoted by the subject application. When the CPU 802 is configured in this way by the application, the CPU 802 becomes a specific purpose computer or a specific purpose machine.

The secondary storage 808 is typically comprised of one or more disk drives, flash memory drives, or tape drives and is used for non-volatile storage of data and as an over-flow data storage device if RAM 804 is not large enough to hold all working data. Secondary storage 808 may be used to store programs which are loaded into RAM 804 when such programs are selected for execution. The ROM 806 is used to store instructions and perhaps data which are read during program execution. ROM 806 is a non-volatile memory device which typically has a small memory capacity relative to the larger memory capacity of secondary storage 808. The RAM 804 is used to store volatile data and perhaps to store instructions. Access to both ROM 806 and RAM 804 is typically faster than to secondary storage 808. The secondary storage 808, the RAM 804, and/or the ROM 806 may be referred to in some contexts as computer readable storage media and/or non-transitory computer readable media.

I/O devices 810 may include printers, video monitors, touch screen displays, keyboards, keypads, switches, dials, mice, track balls, voice recognizers, card readers, paper tape readers, or other well-known input devices.

The network connectivity devices 812 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 812 may provide wired communication links and/or wireless communication links (e.g., a first network connectivity device 812 may provide a wired communication link and a second network connectivity device 812 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an example, the radio transceiver cards may provide wireless communication links using protocols such as code division multiple access (CDMA), global system for mobile communications (GSM), long-term evolution (LTE), WiFi (e.g., IEEE 802.11), Bluetooth, Zigbee, narrowband Internet of things (NB IoT), near field communications (NFC), radio frequency identity (RFID). The radio transceiver cards may promote radio communications using 5G, 5G New Radio, or 5G LTE radio communication protocols. These network connectivity devices 812 may enable the CPU 802 to communicate with the Internet or one or more intranets. With such a network connection, it is contemplated that the CPU 802 might receive information from the network, or might output information to the network in the course of performing the above-described method steps. Such information, which is often represented as a sequence of instructions to be executed using CPU 802, may be received from and outputted to the network, for example, in the form of a computer data signal embodied in a carrier wave.

The CPU 802 executes instructions, codes, computer programs, scripts which it accesses from hard disk, floppy disk, optical disk (these various disk-based systems may all be considered secondary storage 808), flash drive, ROM 806, RAM 804, or the network connectivity devices 812. While only one CPU 802 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 808, for example, hard drives, floppy disks, optical disks, and/or other device, the ROM 806, and/or the RAM 804 may be referred to in some contexts as non-transitory instructions and/or non-transitory information.

In an example, the computing device 108 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an example, virtualization software may be employed by the computing device 108 to provide the functionality of a number of servers that is not directly bound to the number of computers in the computing device 108. For example, virtualization software may provide twenty virtual servers on four physical computers. In an example, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an example, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computing device 108, at least portions of the contents of the computer program product to the secondary storage 808, to the ROM 806, to the RAM 804, and/or to other non-volatile memory and volatile memory of the computing device 108. The CPU 802 may process the executable instructions and/or data structures in part by directly accessing the computer program product, for example by reading from a CD-ROM disk inserted into a disk drive peripheral of the computing device 108. Alternatively, the CPU 802 may process the executable instructions and/or data structures by remotely accessing the computer program product, for example by downloading the executable instructions and/or data structures from a remote server through the network connectivity devices 812. The computer program product may comprise instructions that promote the loading and/or copying of data, data structures, files, and/or executable instructions to the secondary storage 808, to the ROM 806, to the RAM 804, and/or to other non-volatile memory and volatile memory of the computing device 108.

In some contexts, the secondary storage 808, the ROM 806, and the RAM 804 may be referred to as a non-transitory computer readable medium or a computer readable storage media. A dynamic RAM example of the RAM 804, likewise, may be referred to as a non-transitory computer readable medium in that while the dynamic RAM receives electrical power and is operated in accordance with its design, for example during a period of time during which the computing device 108 is turned on and operational, the dynamic RAM stores information that is written to it. Similarly, the CPU 802 may comprise an internal RAM, an internal ROM, a cache memory, and/or other internal non-transitory storage blocks, sections, or components that may be referred to in some contexts as non-transitory computer readable media or computer readable storage media.

In an example, the CPU 802 controls, drives, or otherwise interacts with the display device 102 to cause the display device 102 to display images on the first display panel 204 and/or the second display panel 214, as described above. For example, the CPU 802 controls the light source 302 to illuminate the first display panel 204 and/or the second display panel 214 to cause the first display panel 204 and/or the second display panel 214, respectively, to display images. In other examples, the CPU 802 controls the controller 304 to control the light source 302 to illuminate the first display panel 204 and/or the second display panel 214 to cause the first display panel 204 and/or the second display panel 214, respectively, to display images.

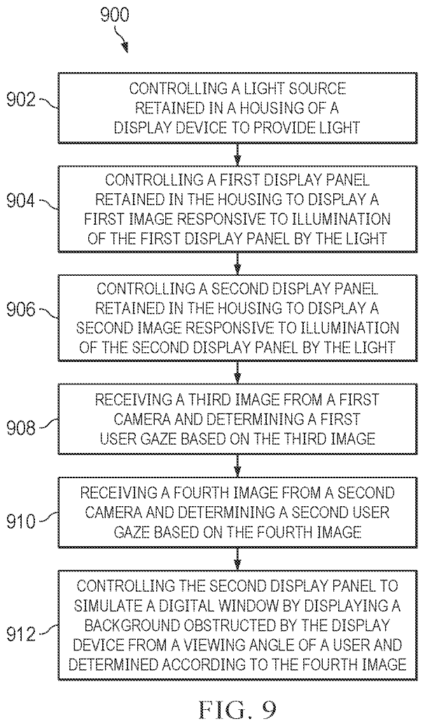

FIG. 9 is a flowchart of a method 900, in accordance with various examples. In some examples, the method 900 is implemented by the display device 102, the computing device 108, or a combination thereof. For example, the method 900 may be implemented to cause a light source, such as the light source 302, to illuminate multiple display panels, such as the display panels 204, 214, retained in a same housing, such as the display device 102.

At operation 902, the computing device 108 controls the light source 302 to provide light. In some examples, the computing device 108 controls the light source 302 to emit or provide light simultaneously to the display panel 204 and the display panel 214, while in other examples the computing device 108 controls the light source 302 to provide the light in a modulated, or time-multiplexed manner.

At operation 904, the computing device 108 controls the display panel 204 to display a first image responsive to illumination of the display panel 204 by the light emitted by the light source 302. In some examples, the first image is an application window of a graphical user interface, an image captured by a camera, or a combination thereof. For example, the computing device 108 controls the display panel 204 to display a first image responsive to illumination of the display panel 204 by the light emitted by the light source 302

At operation 906, the computing device 108 controls the display panel 214 to display a second image responsive to illumination of the display panel 14 by the light emitted by the light source 302. In some examples, the second image is an application window of a graphical user interface, an image captured by a camera, or a combination thereof. In some examples, the display panel 204 and the display panel 214 are oriented in the housing of the display device 102 having different viewing angles, as described above.

At operation 908 the computing device 108 receives a third image from a first camera, such as one or more of the cameras 206 having a field of view overlapping with a viewing angle of the display panel 204. In some examples, the computing device 108 controls the display panel 214 to modify display of the second image based on the third image. The computing device 108 may modify display of the second image based on the third image as described above herein, such as by superimposing the third image over a portion of the second image. In some examples, based on the third image, the computing device 108 determines a user gaze of a user within the viewing angle of the display panel 204, and controls the display panel 204 to modify display of the first image based on the user gaze of the user. The computing device 108 may modify display of the first image based on the user gaze of the user as described above herein.

At operation 910, the computing device 108 receives a fourth image from a second camera, such as one or more of the cameras 216, having a field of view overlapping with a viewing angle of the display panel 214, and controlling the first display panel 204 to display the first image based on the fourth image. In some examples, the computing device 108 controls the display panel 204 to modify display of the first image based on the fourth image. The computing device 108 may modify display of the first image based on the fourth image as described above herein, such as by superimposing the fourth image over a portion of the first image. In some examples, based on the fourth image, the computing device 108 determines a user gaze of a user within the viewing angle of the display panel 214, and controls the display panel 204 to modify display of the second image based on the user gaze of the user. The computing device 108 may modify display of the second image based on the user gaze of the user as described above herein.

In some examples, the computing device 108 is configured to control the display panels 204, 214 to display a first application window of a graphical user interface as the first image, and display a second application window of the graphical user interface as the second image. In this way, a first user viewing the display panel 204 may view first content displayed via the first application window substantially simultaneously with a second user viewing the display panel 214 to view second content displayed via the second application window.

At operation 912, the computing device 108 controlling the display panel 214 to simulate a digital window by displaying a background obstructed by the display device 102 from a viewing angle of a user and determined according to the fourth image. In such examples, the background obstructed by the display device 102 from the viewing angle of the user as determined according to the fourth image may be the third image, as described above. In some examples, responsive to determining that the viewing angle of the user has shifted from a first user viewing angle to a second user viewing angle, the computing device 108 controls the display panel 204 to modify display of the background from a first display area obstructed by the display device 102 from the first user viewing angle to a background from a second display area obstructed by the display device 102 from the second user viewing angle. In this way, a user experience of the second the user viewing the display panel 214 may be aesthetically enhanced.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. In this description, unless otherwise stated, “about,” “approximately” or “substantially” preceding a parameter means being within +/−10 percent of that parameter. Modifications are possible in the described examples, and other examples are possible within the scope of the claims.

1. A display device, comprising:
a housing;
a first display panel retained by the housing;
a second display panel retained by the housing;
a light source retained by the housing; and
a passive light guide optically coupled between the light source and the first display panel, and between the light source and the second display panel.

2. The display device of claim 1, wherein a front of the first display panel is oriented in an opposite direction from a front of the second display panel.

3. The display device of claim 1, wherein the first display panel and the second display panel comprise liquid crystal displays.

4. The display device of claim 1, wherein the first display panel and the second display panel comprise light emitting diodes.

5. The display device of claim 1, wherein the light source is configured to modulate the emitted light to illuminate the first display panel at a first timing and the second display panel at a second timing.

6. The display device of claim 5, wherein the first timing and the second timing are each at a frequency greater than a flicker fusion frequency.

7. The display device of claim 1, further comprising a first camera having a first field of view overlapping with a first viewing angle of the first display panel, and a second camera having a second field of view overlapping with a second viewing angle of the second display panel.

8. The display device of claim 1, wherein the housing includes a first face having a first aperture and a second face having a second aperture, the first face and the second face parallel to one another, the first display panel is configured to provide a first image viewable at a first viewing angle through the first aperture, the second display panel is configured to provide a second image viewable at a second viewing angle through the second aperture, and the second viewing angle offset from the first viewing angle.

9. A display device, comprising:
a housing;
a first display panel retained by the housing;
a first camera retained by the housing and having a first field of view overlapping with a first viewing angle of the first display panel;
a second display panel retained by the housing;
a second camera retained by the housing and having a second field of view overlapping with a second viewing angle of the second display panel;
a light source retained by the housing, the light source configured to emit light to illuminate the first display panel and the second display panel wherein the light source is a passive device having a first reflective side facing the first display panel and a second reflective side facing the second display panel, wherein the first display panel is configured to receive first light from outside the display device and direct the first light towards the first reflective side of the passive device, the first reflective side of the passive device is configured to reflect the first light towards the first display panel, the second display panel is configured to receive second light from outside the display device and direct the second light towards the second reflective side of the passive device, and the second reflective side of the passive device is configured to reflect the second light towards the second display panel; and
a processor coupled to the first display panel, the second display panel, and the first camera, the processor configured to:
control the first display panel to display a first image; and
control the second display panel to display a second image.

10. The display device of claim 9, wherein the processor is further configured to:
determine, via the first camera, a user view angle; and
modify the display of the first image based on the user view angle.

11. The display device of claim 9, wherein the processor is further configured to:
receive a third image from the second camera; and
display the first image based on the third image.

12. The display device of claim 9, wherein the first image is a first application window of a graphical user interface implemented by the processor, and the second image is a second application window of the graphical user interface.

13. The display device of claim 9, wherein the first image is a copy of the second image.

14. A method, comprising:
controlling a light source retained in a housing of a display device to:
during a first time period produce first light and not produce second light; and
during a second time period, not produce the first light and produce the second light, wherein the second time period is longer than the first time period;
controlling a first display panel retained in the housing to display a first image responsive to illumination of the first display panel by the first light; and
controlling a second display panel retained in the housing to display a second image responsive to illumination of the second display panel by the second light,
wherein the first display panel and the second display panel are oriented in the housing having different viewing angles.

15. The method of claim 14, further comprising:
receiving a third image from a first camera having a field of view overlapping with a viewing angle of the first display panel; and
controlling the first display panel to modify display of the first image based on the third image.

16. The method of claim 15, further comprising:
determining, based on the third image, a user gaze within the viewing angle of the first display panel; and
controlling the first display panel to modify display of the first image based on the user gaze.

17. The method of claim 15, wherein the viewing angle is a first viewing angle and the field of view is a first field of view, the method further comprising:
receiving a fourth image from a second camera having a second field of view overlapping with a second viewing angle of the second display panel; and
controlling the first display panel to display the first image based on the fourth image.

18. The method of claim 14, further comprising:
displaying a first application window of a graphical user interface as the first image; and
displaying a second application window of the graphical user interface as the second image.

19. The method of claim 14, comprising:
receiving a third image from a second camera having a field of view overlapping with a second viewing angle of the second display panel; and
controlling the first display panel to simulate a digital window by displaying a background obstructed by the display device from a user viewing angle and determined according to the third image.

20. The method of claim 19, further comprising:
receiving a fourth image from a first camera having a field of view overlapping with a viewing angle of the first display panel;
determining based on the fourth image that the user viewing angle has shifted from a first user viewing angle to a second user viewing angle; and
controlling the first display panel to modify display of the background from a first display area obstructed by the display device from the first user viewing angle to a background from a second display area obstructed by the display device from the second user viewing angle.
